(19) United States
(12) Patent Application Publication
(10) Pub. No.: US 2024/0315809 A1
(43) Pub. Date: Sep. 26, 2024

(54) DENTAL IMPLANT DEVICE AND SYSTEM

(71) Applicant: ABRACADABRA IMPLANTS LTD., Or Yehuda (IL)

(72) Inventor: Iulian HONIG, Or Yehuda (IL)

(21) Appl. No.: 18/578,735

(22) PCT Filed: Jul. 13, 2022
(86) PCT No.: PCT/IL2022/050760

§ 371 Date: Jan. 12, 2024

(30) Foreign Application Priority Data
Jul. 13, 2021 (IL) 284841

(51) Int. Cl. A61C 8/00

(52) U.S. Cl. CPC A61C 8/0051; A61C 8/0089

(57) ABSTRACT

A dental implant device and system, and in particular to a dental implant abutment that is personally configured and easily implemented by a practitioner. The dental implant device in the form of an abutment base featuring a body having a dual functioning single internal connection interface including a central channel and a seat the body featuring a distal portion comprising an anchor coupling interface; and a proximal portion comprising the dual functioning single internal connection interface wherein the seat is disposed adjacent to a proximal surface of the proximal portion.

### FIELD OF THE INVENTION

The present invention relates to a dental implant device and system, and in particular to a dental implant abutment that is personally configured and easily implemented by a practitioner.

### BACKGROUND OF THE INVENTION

Dental implants are well known in the art and typically include a dental implant anchor securely inserted into the patient's jawbone, an abutment member attached to the dental anchor, and a prosthodontic restoration (crown) that is coupled thereon.

State of the art dental implant systems form a dental implant assembly include an implant anchor, an abutment, and a restoration and/or crown (prosthetic restoration) that are placed and coupled in a stacked manner, one above the other. The anchor is drilled in place within bone tissue, the abutment is coupled to the anchor generally within the soft host tissue (gingiva) and the restoration is coupled to the abutment above the gingiva. The forces acting on the implant assembly are from the restoration, to the abutment and finally onto the anchor.

A common problem with state of the art dental implant assemblies is bone loss in and around the anchor, or breakage of any one of the structures. This is generally due to non-optimal allocation of the forces acting on the different implant assembly structures. Accordingly, proper allocation and transmission of the forces acting on the implant structures is important for the long term durability of the implant.

Correct allocation of forces begins with proper placement of a dental implant anchor within the jawbone, while this is an intended goal; however, generally there are anatomical limitations to where dental implant anchors may be placed within the jawbone. Generally a practitioner is limited by the type of bone, bone density, thickness of bone. Such limitations lead practitioners to place an implant at widely varying angles that are placed irrespective of the location of the future restoration and/or crown.

Such a disconnect between the position of a dental implant anchor within the bone and where the source of the forces acting on the implant assembly, namely, the crown and/or prosthesis, leads to improper allocation of forces in the implant system and directly lead to implant failures.

One approach in an attempt to overcome the problem relative positioning of one or multiple dental implant anchors has been the introduction of multi-unit dental implant abutments, an example of which is shown in FIG. 1A-B. Such multiunit abutments offer a practitioner the opportunity to correct the positioning of dental implant anchor by providing two individual segments each having a coupling interface, respectively labelled ‘A’ and ‘B’. The multi-unit abutment has a first segment and coupling interface ‘A’ that is provided so as to couple with the implant anchor. The second segment and coupling interface ‘B’ provides a coupling interface for coupling a crown or the like restoration at an angle that compensates for the angulated placement of the implant anchor. Accordingly interface ‘B’ allows for correcting the position of the placed implant anchor.

As can be in FIG. 1B the interfaces, ‘A’ and ‘B’, are individual and therefore independent of one another. Therein, each segment and interface ‘A’ and ‘B’ has a separate independent borehole. Furthermore, the boreholes are configured to have a preset angle relative to one another or to the occlusal plane. Generally, the angles are preset by each manufacturer and are about 0 degrees, 17 degrees, 30 degrees, and 45 degrees, among others. In some instances an angle of 52 degrees or 60 degrees may be provided.

The limitation of such multi-unit abutments is twofold. First, the corrective angle is preset, prefabricated, and therefore may not be optimal to the individual. Secondly, the location of the second segment and interface, namely ‘B’, is disposed above segment and interface ‘A’, and necessarily increases the height of the implant abutment. More importantly the location of the second interface ‘B’, introduces an additional limitation, namely that of increased leverage forces acting on the upper portion of the multi-unit abutment, particularly associated with interface ‘B’. Therefore, while attempting to solve one problem, implant anchor positioning, a new problem has been established, namely, increased leverage forces acting on the multi-unit abutment. The increased leverage forces lead to gradual weakening, loosening and eventually breakage of the implant assembly. In some cases bone resorption is exhibited.

State-of-the-art multi-unit abutment systems, much like any prefabricated dental implant system, are limited in that they cannot provide a precise parallel fit between at least two or more adjacent implant abutments on the same dental arch. This limitation is caused by the lack of fine-tuning capabilities particularly in the final stages of dental implant placement, that lead to misalignment and a non-parallel configuration between two adjacent implant abutments.

Accordingly, due to this misalignment, state-of-the-art dental implant assemblies and/or systems do not provide a means to control the force distribution on a dental implant system. This is primarily due to the fact that state-of-the-art dental implant systems are manufactured with predefined and/or specific dimensions and angles. Accordingly, most dental implant systems are manufactured according to specific prefabricated dimensions. Manufacturing limitations force manufactures to provide implant systems with specific dimensions and that cannot provide a solution for every clinical situation at hand. In particular, present-day dental implant devices and systems do not offer an adequate solution for individuals that have existing and/or in-situ dental implants.

### SUMMARY OF THE INVENTION

The dental implant device and system of the present invention overcome the limitation of the prior art by providing a dental implant abutment device and system that is provided so as to allow a practitioner to configure and control the force distribution on an in-situ and/or existing implanted dental implant. Control of masticatory or dislocation force distribution is achieved by reducing leverage forces and ensuring parallel alignment between adjacent implant assemblies and/or native teeth. In particular proper force distribution and parallel alignment is ensured during the final stage of the implant placement.

Embodiments of the present invention are particularly useful for individuals that have divergent and/or non-parallel in-situ implanted dental implant anchors, which are already in place within the jaw. Such divergent in-situ dental implant anchors are challenging in that they require the practitioner to correct the position of the restoration portion relative to the anchor portion of the implant system so as to optimize the force distribution and parallel alignment of the entire dental implant assembly, based on the dental implant anchor placement. Accordingly embodiments of the present invention provide a dental implant abutment system that allows a practitioner to optimize the force distribution along the entire dental implant assembly by way of building parallel alignment between the superstructures and/or restorations that properly rest on the dental implant assembly, while reducing leverage forces.

Embodiments of the present invention provide a practitioner with the ability to correct and/or overcome successive additive errors that occur during the abutment fitting process so as to ensure parallel alignment between at least two abutments. Specifically, embodiments of the present invention provide an abutment base that accounts for up to 95% of the parallel alignment between at least two or more abutments and an abutment base insert is personally configured and a coupling member that accounts for the remaining 5% of the parallel alignment. Accordingly, the insert coupling member can be placed so as to correct and/or overcome any misalignment that exists between the abutment bases.

In embodiments, at least one configurable parameter may be the degree of corrective alignment allotment. Within the context of this application the degree of corrective alignment allotment refers to an added degree of alignment correction, so as to allow a practitioner to correctly align adjacent abutments in parallel alignment, most preferably at the time of placement and/or fixation of the abutment.

Embodiment of the present invention provide a dental implant abutment formation assembly kit comprising:
at least two abutment base members according to the present invention;
a parallel guide member featuring at least two parallel bores each bore corresponding to each of the at least two abutment base members;
at least two injection sleeves associated with the parallel guide member; each injection sleeve featuring a distal body member, a medial flange and a proximal body member and an injection channel; and wherein at least a portion of the proximal body member is disposed internal to the parallel bores; at least two coupling member each associated with the distal body member of the injection sleeve; and wherein the at least two coupling members are configured to be associated with the at least two abutment base members.

In embodiments the assembly kit further comprises at least two post members corresponding to each of the at least two coupling members and/or the at least two abutment base members.

In embodiments the assembly kit further comprises at least two sleeve member corresponding to each of the at least two post members.

In embodiments the assembly kit further comprises at least two fixation screws for each of the abutment base members.

In embodiments the assembly kit further comprises a driver tool member, the tool member featuring: a proximal end having a tooling interface for manipulating the driving tool; a body; and a distal end featuring a cap member and cap holding arms, wherein the cap holding arms extend from the body to secure the cap member and wherein the cap holding arms are configured to disassociate from the cap member when rotational force is applied along the driver.

Embodiment of the present invention provide a dental implant abutment base assembly comprising at least two abutment bases, each abutment base featuring a body having a dual functioning single internal connection interface including a central channel and a seat, the body featuring a distal portion and a proximal portion; and the distal portion comprises an anchor coupling interface configured to be seated with to an implanted in-situ dental implant anchor; and the proximal portion comprising the dual functioning single internal connection interface, wherein the central channel spans both the distal portion and a proximal portion; and wherein the seat is disposed adjacent to a proximal surface of the proximal portion; and wherein the seat is configured to receive a coupling member.

Within the context of this application the term prosthodontic restoration, prosthesis, and/or restoration and/or superstructure may refer to a crown, bridge, denture, or the like structure(s) alone or in combination that facilitate in holding, replacing, the visible portion of a prosthetic tooth.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

As used herein, the indefinite articles “a” and “an” mean “at least one” or “one or more” unless the context clearly dictates otherwise.

Herein the term “proximal” generally refers to the side or end of a device that is intended to be closer to the performing practitioner, further from the location of the intervention. The term “distal” generally refers to the side or end of a device that is intended to be closer to or at the location of the intervention, and therefore further away from the performing practitioner.

Importantly, this Summary may not be reflective of or correlate to the inventions protected by the claims in this or continuation/divisional applications hereof. Even where this Summary is reflective of or correlates to the inventions protected by the claims hereof, this Summary may not be exhaustive of the scope of the present inventions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-B are schematic illustrative of prior art multi-unit abutments have two independent and/or individual connection interfaces. FIG. 1A shows a side view; FIG. 1B shows a sectional side view of FIG. 1A showing a first internal connection interface ‘A’ and a second external connection interface ‘B’;

FIG. 2A-C show schematic illustrative diagrams of an abutment base according to embodiments of the present invention having a single internal connection interface configured for servicing two independent dental implant structures; FIG. 2A shows a lengthwise sectional view; FIG. 2B shows a perspective side view; FIG. 2C shows a sectional view of FIG. 2B;

FIG. 3A-E are schematic illustrative diagrams of an abutment base according to embodiments of the present invention, depicting stages of its formation; FIG. 3A shows an unadjusted abutment base blank; FIG. 3B shows a surfaced abutment base;

FIG. 3C-3D show an optional abutment base with a seat; FIG. 3E shows a top down view of abutment base upper surface; FIG. 3F shows a perspective view of an abutment base; FIG. 3G shows a lengthwise sectional view of the abutment base;

FIG. 4A-C are schematic illustrative diagrams of the abutment base according to embodiments of the present invention with an in-situ dental implant anchor; FIG. 4A shows sectional view of divergent in-situ dental implants as used with the abutment base according to embodiments of the present invention; FIG. 4B-4C shows configuration of the abutment base according to embodiments of the present invention relative to the angular relationship between adjacent in-situ dental implant anchors;

FIG. 5A-D are schematic illustrative diagrams of the abutment base with different configurations of the coupling member, according to embodiments of the present invention; FIG. 5A-B show the coupling member having variable angular configuration; FIG. 5C-D show the coupling member in variable vertical positioning;

FIG. 6A-6D are schematic illustrative diagrams of an optional coupling members according to embodiments of the present invention; FIG. 6A showing an optional female coupling member and FIG. 6B showing an optional male coupling member corresponding to the female coupling member shown in FIG. 6A; FIG. 6C shows a perspective view of a non limiting example of a coupling member; FIG. 6D shows a sectional view of a non-limiting example of a coupling member;

FIG. 7A-G are schematic illustrative diagrams of a dental prosthesis connecting device and/or abutment posts according to embodiments of the present invention;

FIG. 8 is a schematic illustration of a parallel guide member according to embodiments of the present invention; and

FIG. 9A-D show schematic illustrative diagrams of optional sleeve members according to embodiments of the present invention. FIG. 9A shows an optional sleeve member having a smooth external surface; FIG. 9B shows an optional sleeve member having a retentive external surface; FIG. 9C shows an optional short and flanged sleeve member having a retentive external surface; FIG. 9D shows a cross sectional view of sleeve member of FIG. 9C having an internal retentive surface;

FIG. 10A-B show schematic illustrative diagrams of an optional injection sleeve members according to embodiments of the present invention. FIG. 10A shows a sectional view of the injection sleeve; FIG. 10B shows a perspective view of the injection sleeve;

FIG. 11A-C show schematic illustrative diagrams of an optional driving tool members according to embodiments of the present invention. FIG. 11A shows a perspective view of the driver; FIG. 11B shows a sectional view of the driving tool; FIG. 11C shows a further sectional view of the driving tool; and

FIG. 12 shows a schematic illustrative diagram of an abutment base assembly according to optional embodiments the present invention.

### DESCRIPTION OF THE PREFERRED EMBODIMENTS

The principles and operation of the present invention may be better understood with reference to the drawings and the accompanying description. The following figure reference labels are used throughout the description to refer to similarly functioning components are used throughout the specification hereinbelow.
50 in-situ implanted dental implant anchor;
55 fixation screw;
100 abutment base;
100r abutment base reference marking;
102 body;
104 dual connection interface;
105 central channel;
110 distal portion;
112 anchor coupling interface;
120 proximal portion;
122 proximal surface;
124 seat;
124a seat axis;
126 coupling member(s);
126a coupling member axis;
126c central recess/lumen;
126t threaded coupling members;
126m male coupling member;
126f female coupling member;
200 dental prosthesis connecting device/post;
202 coupling platform;
204 proximal portion;
204r retentive proximal portion;
204s snap fit proximal portion;
204t threaded proximal portion;
206 tooling interface;
208 post channel;
300 sleeve member;
302 sleeve external surface;
304 sleeve retentive surface;
306 sleeve internal retentive surface;
400 parallel guide member;
402 body;
404 parallel bore;
500 injection sleeve;
502 distal body member;
504 medial flange (504);
506 proximal body;
508 lengthwise injection channel;
600 driver;
601 proximal end;
601 tooling interface;
602 driver body;
604 distal end;
606 cap/plug;
608 cap holding arms;

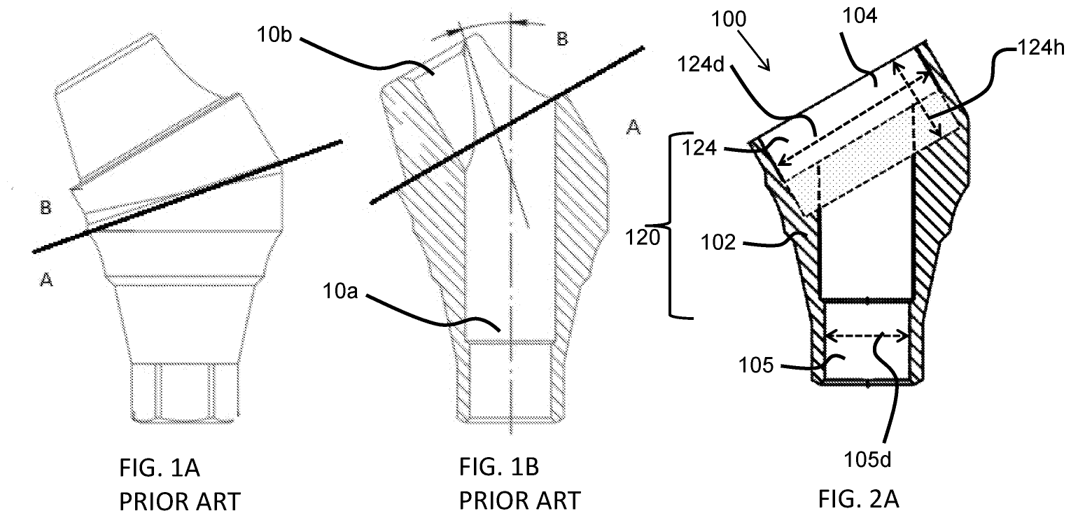

FIG. 1A-B are schematic illustrations of prior art multi-unit abutments that have two independent and/or individual connection interfaces, a first connection interface to affix the multi-unit abutment to the dental implant anchor (not shown), and a second connection interface to affix the restorative superstructure. The prior art multi-unit abutment having a first segment labelled ‘A’ featuring the first connection interface and a second segment labelled ‘B’ featuring the second connection interface. The multi-unit abutment and in particular an angled multi-unit abutment is characterized in that the first connection interface 10a is provided at an angle relative to the second connection interface 10b. First interface 10a disposed in first segment ‘A’, is a borehole for receiving a fixation screw to affix it to the dental implant anchor; and second interface 10b, disposed in second segment ‘B’, is a borehole for receiving a superstructure. As discussed above, state-of-the-art multi-unit abutments are limited in that the second segment ‘B’ necessarily increases the overall abutment height, leading to the creation of leverage forces acting along the border defined between segment A and B. Such leverage forces may lead to various mechanical failures such as bone resorption, abutment fractures or breakage, implant anchor fracture or breakage. The primary problem with such prior art multi-unit abutments is the need for two individual axes: a first axis formed with segment ‘A’ and a second axis formed by segment ‘B’, leading to the described mechanical failures.

Furthermore, second interface 10b, according to state-of-the-art multi-unit abutments, is provided with fixed angles with respect to first interface 10a, as discussed above. The fixed angles are generally provided at preset angles of about 0 degrees, 17 degrees, 30 degrees, or 45 degrees. In some instances, an angle of 52 degrees or 60 degrees may be provided.

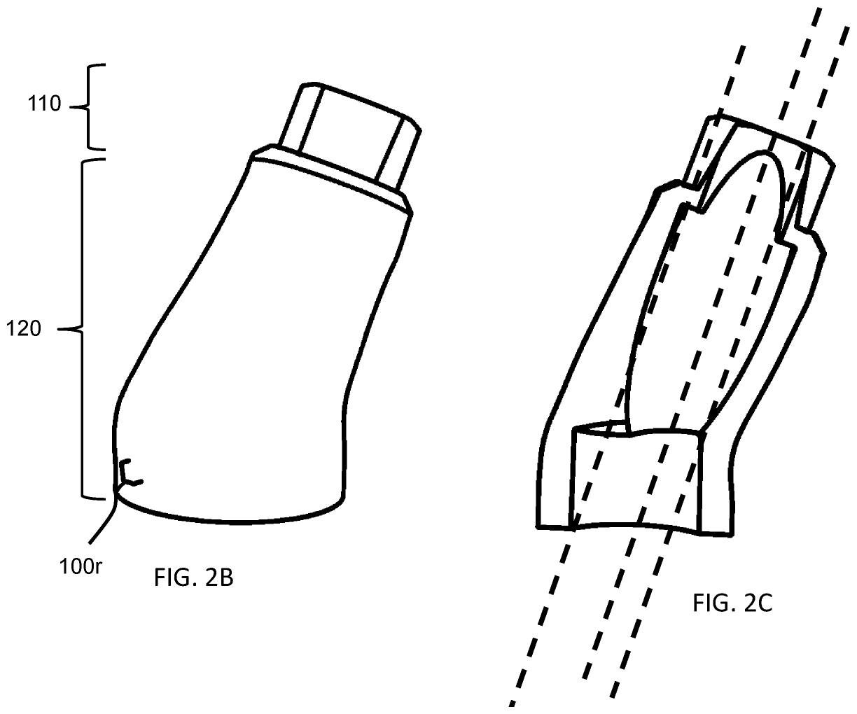

Now referring to FIG. 2A-C, that shows a schematic illustrative diagram of the abutment base 100 according to embodiments of the present invention. Abutment base 100 comprises a body 102 featuring a single internal connection interface 104 that is dual functioning including a central channel 105 and a seat 124. The seat 124 is configured to have a seat axis 124a that is up to about 60 degrees relative to a central axis 100a of abutment 100.

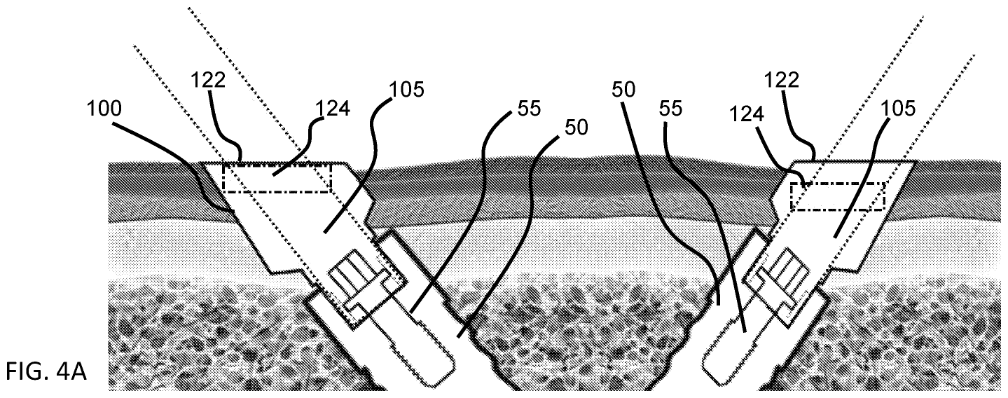

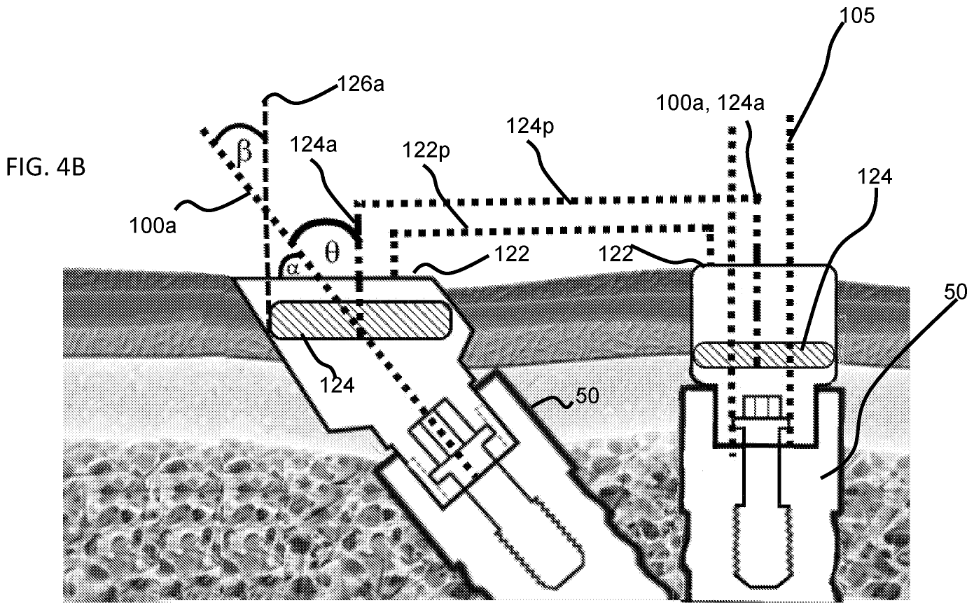

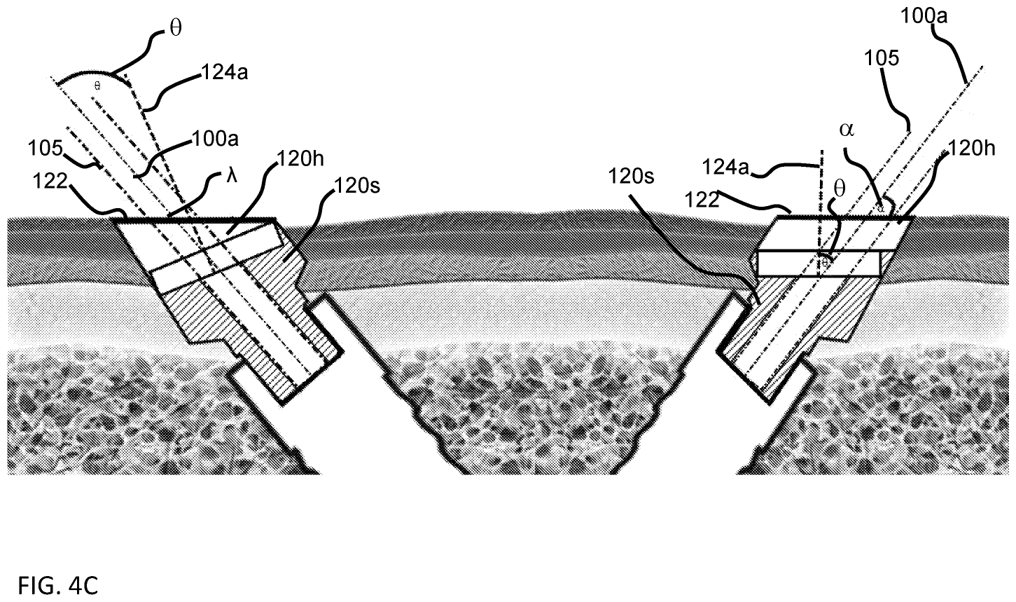

As appreciated by those skilled in the art, abutment 100 according to embodiments of the present invention provides for eliminating unnecessary leverage forces by providing abutment 100 with a single connection interface 104 having dual functionality, while maintaining a single common axis 100a for abutment 100, as best seen in FIG. 4B.

In embodiments, the proximal portion 120 of abutment base 100, namely above the dental implant anchor surface, is configured to have a height of at least 2 mm (millimeter) and up to about 14 mm (millimeter) so as to ensure that dual functioning single internal connection interface 104 is disposed in a manner that reduces the leverage forces acting on the abutment during use.

In embodiment abutment base 100 is configured to provide a dual functioning single internal connection interface 104, wherein central channel 105 and a seat 124 are configurable relative to one another. Particularly, according to embodiments of the present invention seat 124 is configurable relative to central channel 105 according to at least one or more parameters. Seat parameters may for example include but are not limited to angle, location, dimensions, height, width, degree of corrective alignment allotment, or any combination thereof.

In embodiments dual functioning single internal connection interface 104 provides a single access point to the implanted dental implant anchor 50 from the proximal surface 122, while maintaining a continuous external surface along proximal portion 120. Such a continuous external surface 122 improves healing process of the host tissue surrounding the proximal portion 120 and in particular the soft tissue and/or gingival tissue that interfaces with the proximal portion 120 of abutment base 100.

In embodiments, at least one configurable parameter may be the degree of corrective alignment allotment. Within the context of this application the degree of corrective alignment allotment refers to an added degree of alignment correction, so as to allow a practitioner to correctly align adjacent abutments in parallel alignment, most preferably at the time of placement and/or fixation of the abutment. Accordingly, degree of corrective alignment allotment refers to the dimensions of seat 124 that is provided with up to 5 degrees of alignment corrective capability.

In embodiments central channel 105 may be configured to have a diameter 105d of at least 2 mm.

In embodiments seat 124 is configured to have diameter 124d of at least about 2 mm and up to about 12 mm and a vertical dimension 124h of at least 1 mm.

In embodiments, abutment base 100 may be configured to have an external diameter from about 3 mm and up to about 15 mm.

In embodiments abutment base 100 may feature a reference marking 100r to facilitate proper positioning. Preferably marking and/or reference point 100r is preferably disposed about the external surface of proximal portion 120, for example as shown in FIG. 2B.

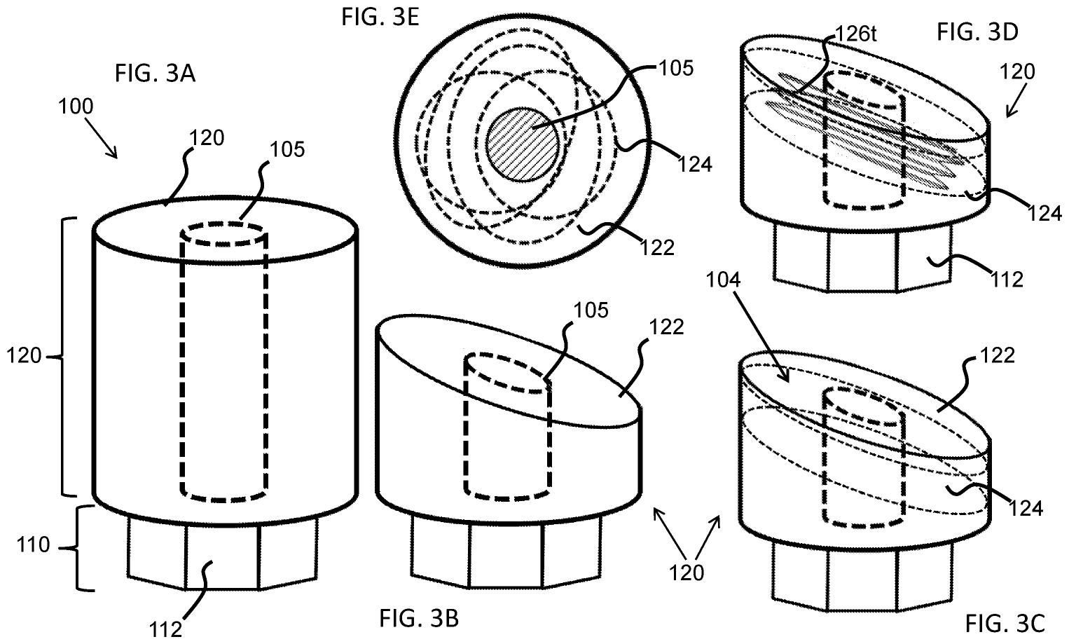

In embodiments abutment base 100 may be formed by milling and/or 3D printing techniques, or the like computer assisted design and/or manufacturing (CAD/CAM) techniques as is known in the art. For example, in some embodiments as depicted in FIG. 3A-E, abutment base 100 may initially be provided as a blank, for example as shown in FIG. 3A, that is configured to its optimal dimensions, based on at least one or more parameters, for a particular individual and for a particular placement on a dental arch. Based on the configured optimal dimensions the blank is then milled and/or printed according to the specification, for example as shown in FIG. 3C-D.

FIG. 3A shows a schematic illustrative diagram of an abutment base 100 in its blank form prior to milling. Abutment base 100 comprises a central lengthwise channel 105, a distal portion 110 and a proximal portion 120. Channel 105 spans the length of abutment base 100.

Distal portion 110 is configured to provide a dental implant anchor coupling interface 112. Coupling interface 112 allows for seating the abutment base 100 onto an implanted in-situ dental implant anchor 50, shown in FIG. 4A-B. Abutment base 100 may be affixed to an in-situ dental implant anchor 50, a non-limiting example of which may be a fixation screw 55, for example as shown in FIG. 4A. In embodiments, coupling interface 112 may be provided in many optional forms as is known in the art, for example including but not limited to a hexagonal form, a non-limiting example of which is shown. Accordingly, interface 112 may be provided in optional configuration for connecting to any connection platform type or geometric configuration, internal or external, provided by an in situ dental implant anchor 50.

FIG. 3A, shows proximal portion 120 in its blank form prior to milling and/or machining with a CNC machine. In some embodiments proximal portion 120 may optionally be provided in a blank form so as to allow personalization of abutment base 100 to properly fit and to further allow for proper allocation and distribution of the forces acting on the dental implant assembly. The optimal configuration and parameters for proximal portion 120 is determined based on an analysis of medical imagery and/or scan taken of the oral cavity, not shown. Such parameters may for example include but are not limited to height, surface angulation, contour, diameter, any combination thereof or the like.

FIG. 3B shows an abutment base 100 in its intermediate form where at least the height and surface angulation of the proximal portion 120 have been determined. Accordingly, FIG. 3B is a schematic depiction of a partially milled blank proximal portion of FIG. 3A. FIG. 3B shows that central channel 105 is maintained while the height has been reduced and the upper surface of proximal portion, proximal surface 122, has been established, most preferably based on medical imagery of the oral cavity.

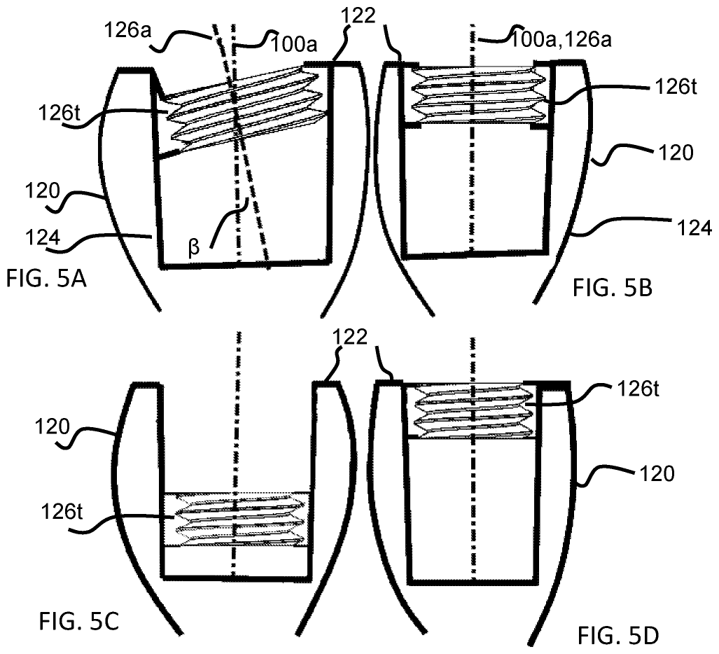

FIG. 3C shows a further intermediate depiction of abutment base 100 wherein, the proximal portion 120 is configured to be fit with a seat 124, therein forming dual functioning single internal connection interface 104. Seat 124 provides a connection platform so as to allow the formed abutment base 100 to be coupled and/or secured with a post 200 acting as an abutment central axis, examples of which are shown in FIG. 5A-D.

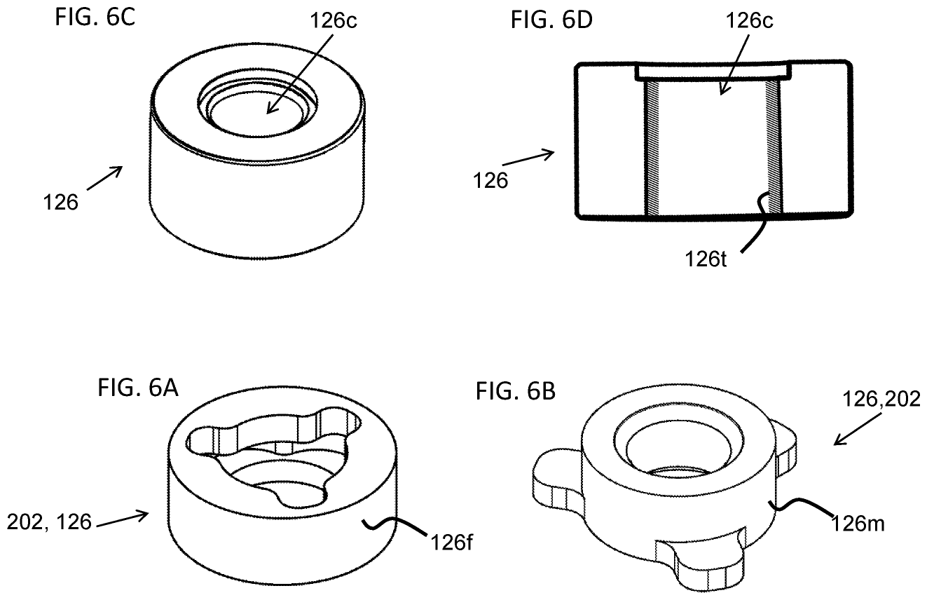

FIG. 3C shows an abutment base 100 featuring a seat 124 that is disposed along an internal surface of proximal portion 120. In such a configuration proximal portion 120 is configured to receive a coupling member 126 (FIG. 3D, FIG. 6A-D) along an internal recess 124 within proximal portion 120.

FIG. 3D shows a formed abutment base 100 wherein the proximal portion 120 has been formed to include an internal seat 124 along an internal recess of proximal portion 120 and is fit with an optional coupling member 126 shown in the optional form of threading 126t, along an internal surface thereof.

In embodiments seat 124 may be fit with optional coupling members 126 for example including but not limited to snap fit couplers, threaded couplers, friction fit couplers, male/female couplers, turn-lock couplers, or the like, FIG. 6A-D. FIG. 6A-6B show an optional configuration for a coupling member 126 shown in the form of corresponding male and female turn-lock coupling members 126. FIG. 6B shows a schematic illustration of an optional turn-lock male coupling member 126m. FIG. 6A shows a schematic illustration of an optional turn-lock female coupling member 126f. In embodiments male turn-lock coupling member 126m is configured to be fit and coupled with the corresponding female turn-lock coupling member 126f. As shown, the turn-lock coupling members may feature a multi-lobe configuration, shown in the form of a trilobe configuration as shown that is configured to mate with corresponding male-female configurations.

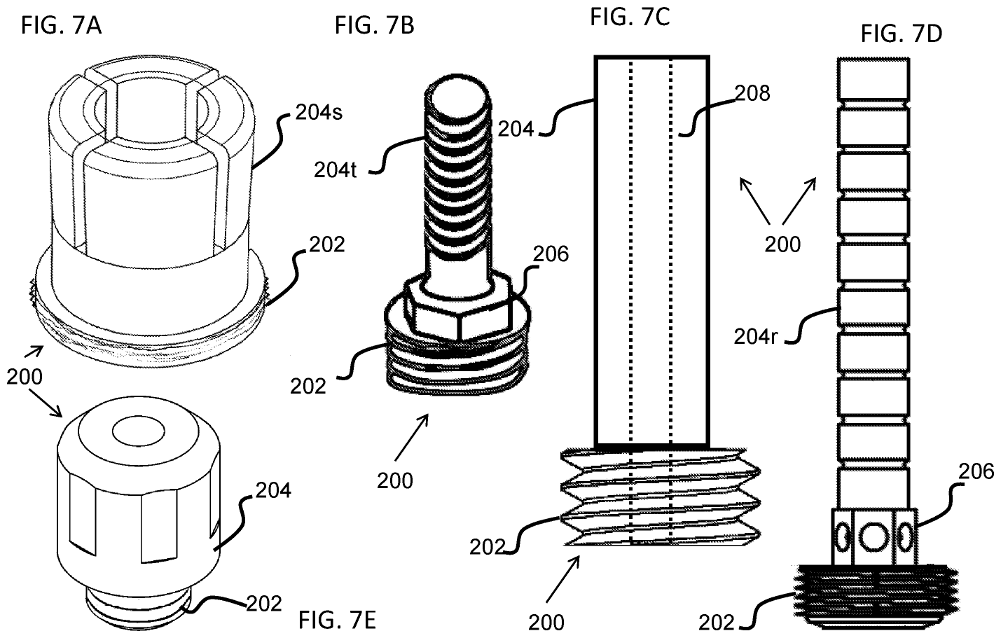

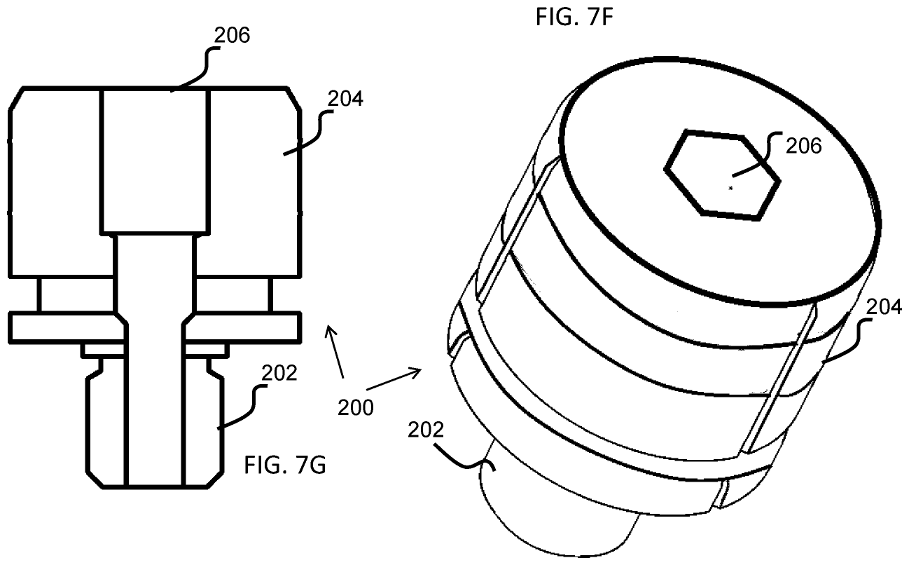

FIG. 6C-D shows an optional coupling member 126 having a central open recess and/or lumen 126c. FIG. 6C shows a perspective side view of coupling member 126 having a cylindrical body and featuring a central channel and/or recess and/or lumen 126c that features an internal coupling interface, that may be provided in optional forms for example including but not limited to threading, friction fit, snap fit, the like, or any combination thereof. Preferably, internal coupling interface of channel 126c is provided for associating and securely coupling with a post 200, FIG. 7A-G, along a corresponding coupling portion thereof.

FIG. 6D shows a sectional view, where coupling member 126 is configured as a cylindrical body having a central channel 126c that features an internal coupling interface in the non-limiting form of threading 126t, for example as shown. Preferably threading 126t is configured to match and couple corresponding threading provided on a post member 200, examples of which are depicted in FIG. 7A-G. In some embodiments, coupling members 126 may be configured to provide a central channel 126c that features a snap fit and/or friction fit type coupling interface, for example as shown in FIG. 6C.

Most preferably, coupling member 126 is configured to fit within seat 124 so as to provides the degree of corrective alignment allotment, so as to allow proper parallel alignment between abutments on the same dental arch. Preferably, such a fit allows to correct cumulative misalignment, and/or alignment errors, between at least two or more abutment base members. Such a correction is provided so as to ensure proper parallel alignment and telescopic alignment between at least two or more abutments. Therefore while each seat 124 is configured to be in parallel alignment relative to its neighboring seat 124 of a respective abutment base 100, along the same dental arch, however, coupling member 126 is provided for correcting any additive and/or cumulative parallel mis-alignment between abutment bases 100 and seats 124. In embodiments, coupling member 126 may be fit within seat 124 providing at least 5% and up to 50% alignment adjustment so as to correct any cumulative alignment errors. That is coupling member 126 is capable of fine tuning and/or adjustment of alignment within respective seats 124 of each abutment bases 100, along the same arch so as to ensure proper parallel alignment is indeed achieved. In embodiments, coupling member 126 may be adjusted within seat 124 by 0.2 mm (millimeters) and up to about 1.5 mm (millimeters) so as to ensure that coupling members are properly aligned between at least two or more abutments along the same arch. Such fine tuning parallel alignment is not possible with present day devices and therefore overcomes a continuing problem in the art.

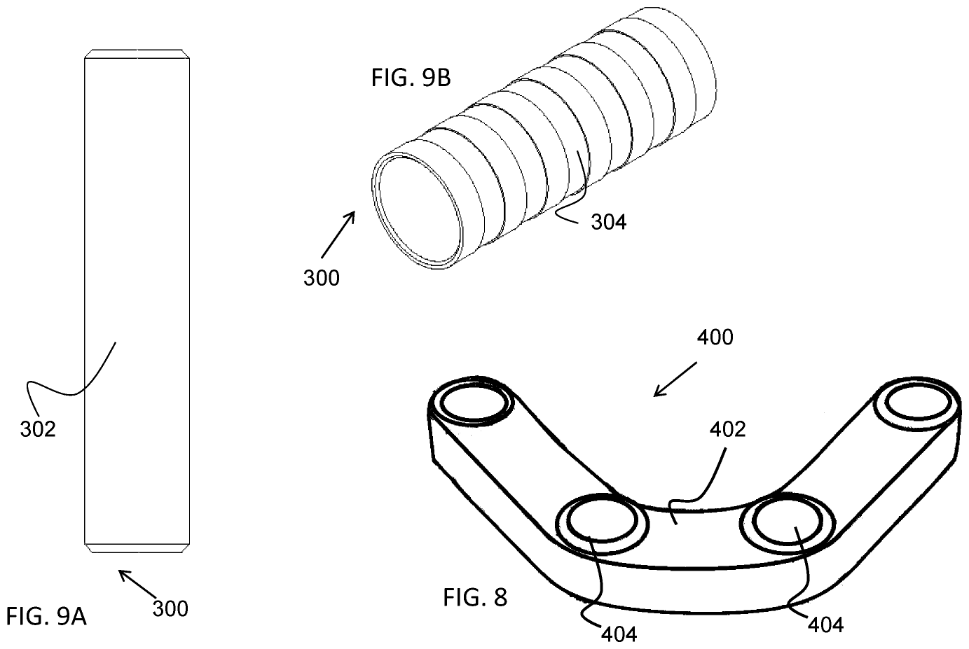

In embodiments, such alignment correction is provided with the use of tool such as alignment tool 400 shown in FIG. 8, that may be utilized to facilitate such parallel alignment, so as to overcome the accumulated misalignment between at least two or more abutment bases.

In embodiments, seat 124 and/or post 200 may be configured to fit with either of the corresponding male coupling member 126m and/or female coupling member 126f, for example shown in the form of the displayed turn lock configuration.

In embodiments an internal seat 124 is configured to envelope channel 105 therein forming a dual functioning single internal connection interface 104, for example as shown in FIG. 3C. In some embodiments channel 105 may be utilized as a means to allow a fixation screw 55 to be introduced therethrough.

FIG. 3E shows that the seat 124, shown in broken lines, may be disposed and/or located along any portion of proximal surface 122 and is not necessarily centered about channel 105. As shown, seat 124 does not have to be centered about channel 105 and can be placed along a portion of surface 122 that encompasses channel 105. Accordingly, as previously described coupling member 126 provides for further fine tuning the final positioning of seat 124 such that it provides proper parallel alignment.

In embodiments seat 124 may be disposed within proximal portion 120 at any distance distal from proximal surface 122. In embodiments seat 124 may be disposed up to about 5.5 mm (millimeters) from upper proximal surface 122.

In embodiments, a blank proximal portion 120 may further be configured in and around seat 124 so as to be solid, or hollow, or partially hollow, or trabecular, or intermittently hollow or the like, for example by way of milling blank proximal portion 120 and/or by way of printing proximal portion 120.

In embodiments the degree of hollowness of proximal portion may be up to about 90% of the volume of the proximal portion. Preferably, the degree of hollowness is determined by the dimensions of the dual functioning single internal connection interface 104.

In embodiments the degree of hollowness of proximal portion may be up to about 60% of the volume of the proximal portion. Preferably, the degree of hollowness is determined by the dimensions of the dual functioning single internal connection interface 104.

In embodiments the degree of hollowness of proximal portion may be configured to be from about 20% of the volume of the proximal portion. Preferably, the degree of hollowness is determined by the dimensions of the dual functioning single internal connection interface 104.

In some embodiments, abutment base 100, for example as schematically depicted in FIGS. 3D, FIG. 2A-B may be formed by way of three-dimensional printing techniques as is known in the art of 3D printers, or the like CAD/CAM systems.

FIG. 4A shows a couple of in-situ implanted dental implants 50 that need to be fit and/or secured with an abutment base according to embodiments of the present invention. A non-limiting example of a means for coupling an abutment and implant is a fixation screw 55, as shown. Other optional fixation and/or coupling means between abutment and implant may be utilized. As shown, the divergent and sharp angulation of implants 50 relative to one another limits a practitioner from utilizing prior art abutments as prior art abutments cannot properly overcome such divergent implant placement without jeopardizing the stability of the implant assembly. Improper placement on such divergent implants will lead to improper allocation of forces acting along the dental implant assembly. Furthermore, such divergent dental implant anchors, that are fit with prior art abutments, are prone to misalignment and therefore mismanagement of the distribution of forces along the length of the dental implant assembly which further places undue stress on both the hard tissue (bone) and soft tissue (gingiva) surrounding the implant anchor. Commonly such mismanagement of forces acting on the implant lead to breakage and ultimate failure of the implant.

Accordingly an abutment base 100 according to embodiments of the present invention can compensate so as to overcome the divergent placement of the implant anchors 50. By way of properly configuring the proximal portion 120 and in particular the dual functioning single axis, single internal connection interface 104 wherein the location and angulation of the post coupling seat 124 of the proximal portion 120, affords the in-situ implants 50 to be fit with an abutment that properly distributes forces along its length and further compensates for the divergent and/or angulated placement of the implant anchors 50.

As described above, post coupling seat 124 may be disposed at any height and/or angle relative to the upper proximal surface 122 of portion 120. In embodiments seat 124 may be disposed up to about 5.5 mm (millimeters) from upper proximal surface 122. For example as schematically shown, on the left implant anchor (FIG. 4A), seat 124 is disposed immediately adjacent to surface 122, while, on the right implant anchor; seat 124 is disposed distal to the upper proximal surface 122.

FIG. 4B shows a further schematic depiction of two in-situ implanted dental implants 50 that are fit with an abutment base 100 according to embodiments of the present invention. Each in-situ implant 50 is positioned within the host tissue in a different orientation and therefore each of the abutment bases 100 will be individually configured accordingly so as to ensure proper placement and proper allocation of forces acting on the dental implant assembly thereby overcoming the angulation of the in-situ implant 50. This is accomplished by controlling the placement of seat 124 forming the dual functioning single internal connection interface 104.

In embodiments abutment base 100 is provided with dual functioning single internal connection interface 104 including a seat 124 that is configured at variable height within the proximal portion 120 and relative to proximal surface 122. In embodiments where two or more abutment bases 100 are utilized, each of the seats 124 have an axis 124a configured to be in parallel alignment with one another, as is shown with parallel line 124p.

In embodiments, seat 124 may be configured and/or positioned so that its central axis 124a is positioned at an angle theta (θ) relative to the central axis 100a of abutment base 100, and wherein theta is up to 60 degrees. For example, as shown in FIG. 4B the left side abutment base shows theta having an angle of about 40 degrees, while the right side abutment base has a theta angle of about 0 degrees, as both the abutment central axis 100a and the seat axis 124a are in alignment.

In embodiments the proximal surface 122 of each abutment base 100 is configured to be parallel to one another as is shown with parallel lines 122p.

In embodiments surface 122 is configured to form an angle alpha (α) with respect to the abutment base central axis 100a, as is shown. In embodiments surface 122 is configured so as to have a minimal angle alpha (α) of no less than 30 degrees relative to axis 100a.

In embodiments, abutment base 100 and in particularly seat 124 may be configured to feature and/or receive a coupling members 126 at an angle beta (β) relative to central axis 100a. In embodiments angle beta (β) is up to about 60 degrees.

As previously described most preferably seat 124 is configured to further provide a practitioner with an additional degree of corrective alignment allotment. Such additional degree of corrective alignment is necessary as to provide the necessary angulation to ensure parallel alignment between abutments and so as to correct successive and/or accumulated alignment errors that accumulate during the restoration process.

FIG. 4C is similar to FIG. 4B showing various configurations of abutment base 100 and in particular the relative positioning of seat 124 within proximal portion 120 relative to abutment base axis 100a. As shown, left side abutment base 100 shows seat 124 having an angle theta (θ) defined between axis 124a and central axis 100a, and further comprises an angle lambda (2) relative to proximal surface 122. In embodiments angle lambda (2) may be up to about 90 degrees. For example on the right side abutment base 100 is configured to have a lambda of about 90 degrees while on the left side abutment base 100 seat 124 is configured to have a lambda angle of about 60 degrees.

Further FIG. 4C shows that proximal portion 120 may be configured to be solid, or hollow, or partially hollow, or trabecular, or intermittently hollow or the like. For example, as shown in FIG. 4C proximal portion 120 distal to seat 124 is configured to be solid 120s while proximal to seat 124 proximal portion is configured to be hollow 120h.

FIG. 5A-D are schematic illustrative diagrams of the proximal portion 120 of abutment base 100 wherein the positioning and orientation of the coupling member 126 within seat 124 is shown in variable optional configuration. While FIG. 5A-D show coupling member in the form of threading, embodiments of the present invention are not limited to threading and may be provided in any form for example including but not limited to male/female couplers, turn lock members (FIG. 6A-6B), snap fit or the like.

FIG. 5A-B depicts a coupling member 126 in variable angular orientation positioning relative to at least one of seat 124 or more preferably abutment base axis 100. FIG. 5A shows coupling member 126 in the optional non-limiting form of threading 126t that is configured to have an axis 126a that forms an angle beta (β) relative to central axis 100a, wherein angle beta is about 15 degrees. FIG. 5B shows coupling member 126 in the optional non-limiting form of threading 126t wherein axis 126a and axis 100a are in alignment and therefore angle beta (β) is 0 degrees (zero degrees). In embodiments angle beta (β) may be up to about 60 degrees when comparing abutment axis 100a to the coupling member axis 126a.

FIG. 5C-D shows two abutment base configurations where the vertical location and/or positioning of coupling member 126 is controlled and/or configurable within proximal portion 120 and more preferably within seat 124. FIG. 5C shows and optional coupling member 126 shown in a non-limiting threaded form that is disposed at a distal portion within seat 124 at a distance from proximal surface 122. FIG. 5D shows and optional coupling member 126 shown in a non-limiting threaded form that is disposed at a proximal portion within seat 124 near proximal surface 122.

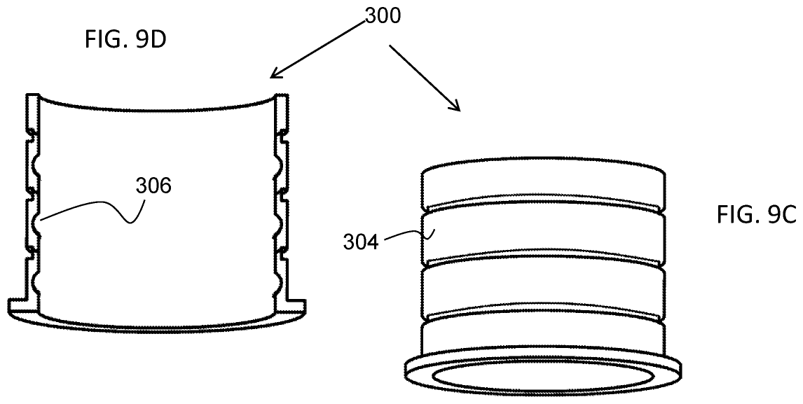

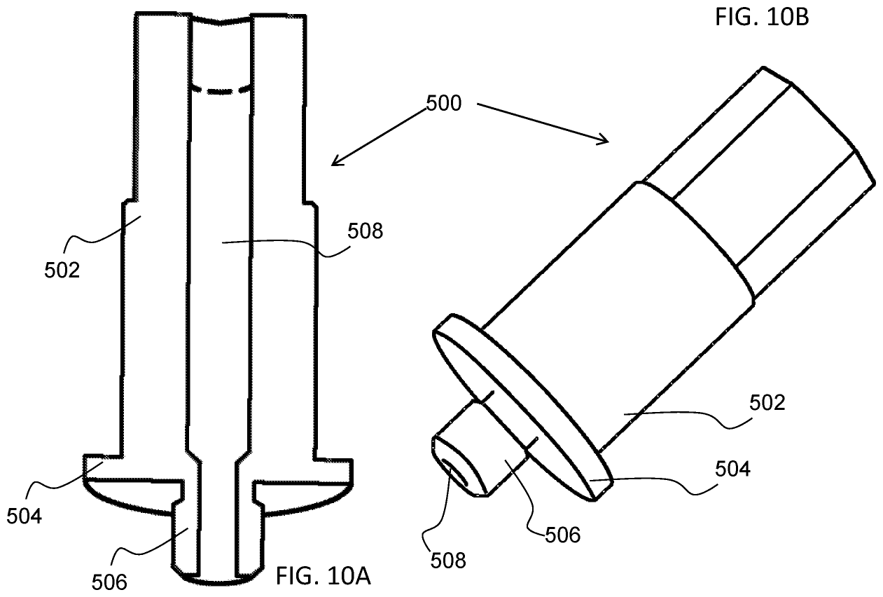

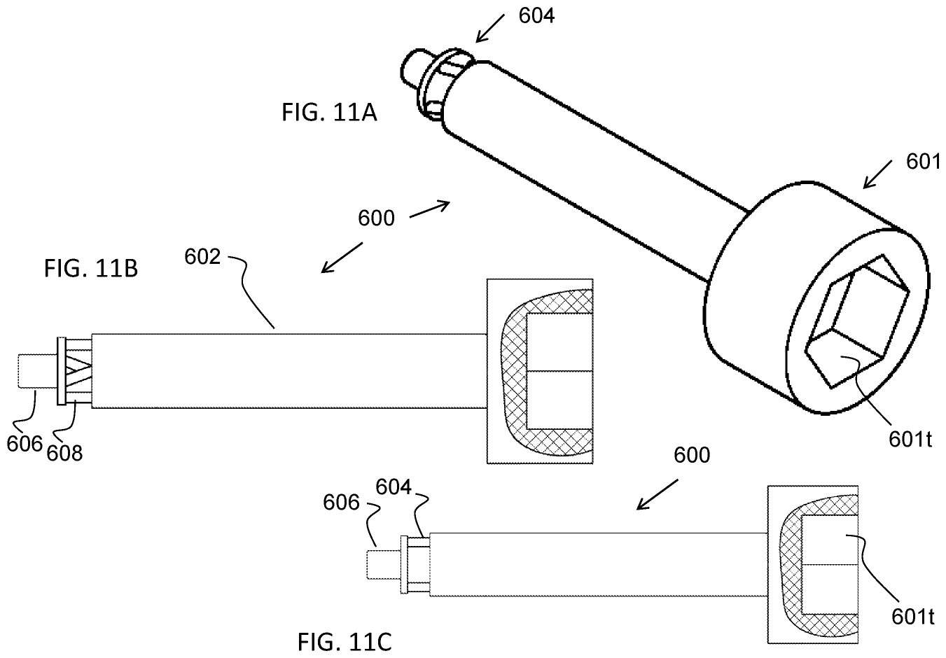

In embodiments the abutment base 100 may be utilized to form an abutment assembly that comprises an abutment base 100 (FIG. 2A-B,3D) and a post 200, shown in FIG. 7A-G. In some embodiments the abutment assembly may further comprise at least one or more sleeve 300, shown in FIG. 9A-D. In some embodiments the abutment assembly may further comprise a parallel alignment guide member 400, shown in FIG. 8. In some embodiments the abutment assembly may utilize an injection sleeve 500, a non limiting example of which is shown in FIG. 10A-B. In some embodiments the abutment assembly may utilize a driver 600, a non-limiting example of which is shown in FIG. 11A-C.

FIG. 7A-E collectively show non-limiting embodiments of different configuration of posts 200 that may be coupled and/or secured and/or affixed with abutment base 100 along post coupling seat 124 and/or coupling member 126 associated therewith. Preferably seat 124 provide a central axis 124a for forming an abutment assembly that is based on abutment base 100 according to embodiments of the present invention.

Most preferably post 200 is provided as a means for coupling with and/or interfacing with a crown and/or restoration and/or super structure.

In embodiments posts 200 are provided with a coupling platform 202 that may be secured with coupling member 126 dispensed within seat 124, and a proximal portion 204 extending proximally from the coupling platform 202. Therein post 200 has a distal coupling platform 202 and a proximal portion 204.

As previously described preferably coupling member 126 is provides a degree of corrective alignment allotment within seat 124 such that when coupled with platform 202 so as to allow adjacent posts 200 to be aligned in parallel with respect to each other, therein overcoming successive additive errors exhibited with state of the art abutment.

In embodiments proximal portion 204 may be provided in any shape and or dimensional configuration.

In some embodiments post 200 may further comprise a tooling interface 206, that is preferably disposed along at least a portion of proximal portion 204, for example as shown in FIGS. 7B and 7D.

FIG. 7A shows an optional coupling interface 200 featuring a coupling platform 202, configured to be coupled to an abutment base 100, within a threaded coupling member 126, having threads 126t. FIG. 7A further shows the proximal portion that is fit with a snap fit configuration 204s so as to fit with a superstructure and/or crown (not shown).

FIG. 7B shows a further optional post 200 featuring a tooling interface 206 disposed along a distal portion of proximal portion 204 and wherein the proximal portion features threading 204t.

FIG. 7C shows a post 200 having a post channel 208, preferably disposed along the length of post 200. As shown coupling platform 202 is provided in the form of threading.

FIG. 7D shows a post having a retentive surface 204r along proximal portion 204.

FIG. 7E-GD show further optional configuration of a post 200 having a retentive surface 204r along proximal portion 204, for example in the form of recesses. FIG. 7F-G show post 200 having a tooling interface 206. In some embodiments coupling platform 202 of post 200 may be fit with threads, a non limiting example of which is shown in FIG. 7E.

In some embodiments proximal portion 204 of post 200 may be configured to receive a tubular sleeve 300, as shown in FIG. 9A-D. Sleeves 300 may be provided to facilitate coupling and/or affixing post 200 to a crown and/or restoration and/or bridge and/or the like superstructure (not shown). FIG. 9A shows a tubular sleeve 300 having an external surface 302. Preferably sleeve 300 is configured to be fit over at least a portion of proximal portion 204 of post 200. FIG. 9B shows an optional sleeve member 300 featuring a retentive external surface 304.

FIG. 9C-D show different views of a further optional sleeve in the form of a short sleeve member 300 having a distal flange; and that further feature both an external retentive surface 304 and an internal retentive surface 306, that preferably facilitates coupling to post 200.

FIG. 8 shows a parallel guide member 400, optionally referred to as a splint, that is configured to urge adjacently placed coupling members 126, and in turn posts 200 associated thereto, that are individually associated with an abutment base 100 into parallel alignment. In embodiments the guide member 400 comprises a rigid body 402 and a plurality of receiving bores 404 that are preferably fabricated to be in parallel alignment based on and specific to an individual's dental arch, such that each guide member is individually configured.

In some preferred embodiments each bore 404 is configured to receive an injection sleeve, shown in FIG. 10A-B, that is loaded with a coupling member 126, and therefore functions to enhances parallel alignment and corrects any additive and/or cumulative parallel mis-alignment between abutment bases.

In some embodiments each bore 404 may be configured to receive a proximal portion 204 of a post 200 so as to urge adjacent posts into parallel alignment with abutment base 100 along seat 124.

FIG. 10A-B show schematic illustrative diagrams of an optional injection sleeve 500 members according to embodiments of the present invention. Injection sleeve 500 is configured to be associated with parallel guide member 400, FIG. 8. Injection sleeve 500 features a distal body member/portion 502, a medial flange 504 and a proximal body member/portion 506 and an injection channel 508 spanning its length. Most preferably, injection sleeve 500 is configured to associate with guide member 400 wherein at least a portion of the proximal body portion 506 is disposed internal to the parallel bores 404 of splint 400.

FIG. 11A-C show schematic illustrative diagrams of an optional driving tool member 600 according to embodiments of the present invention, that is utilized to introduce a cap member 606 to associated with a fixation screw 55 internal to an abutment base 100 according to the present invention. FIG. 11A shows a perspective view of the driver tool 600 featuring a proximal end 601, a body portion 602, and a distal end 604. The proximal end 601 features a tooling interface 601t, the proximal portion and tooling interface utilized for facilitate manipulating the driving tool 600. The distal end 604 features a cap member 606 and cap holding arms 608 that extend from the end of body portion 602. In embodiments holding arms 608 are configured to extend and taper distally from said body 602 so as to secure said cap member 606. Most preferably cap holding arms 608 are configured to disassociate from cap member 606 when a rotational force is applied along said driver 600. Optionally dissociation of cap member 606 may be facilitated with a rotational forces.

FIGS. 11B and 11C show different view so as to reveal the angulation of holding arms 608 of the driving tool 600. The configuration of holding arms 608 are angulated and optionally tapered to facilitate disassociation from cap member 606 from driving tool 600.

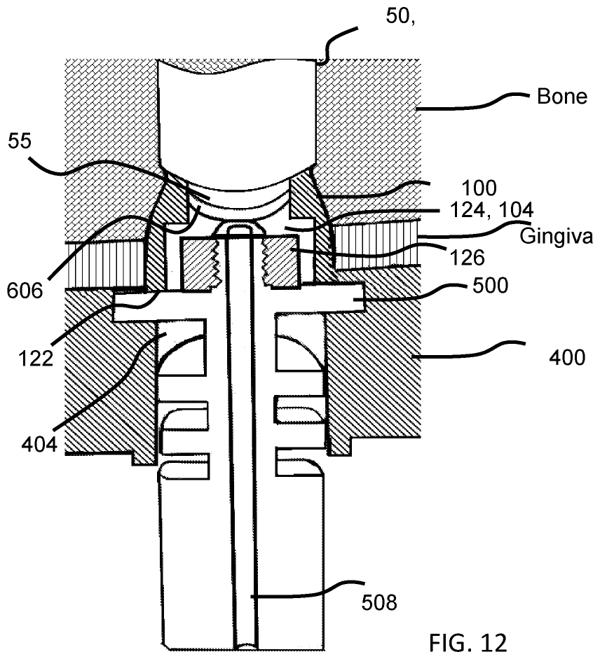

FIG. 12 shows a schematic illustrative diagram of an abutment base assembly as assembled onto dental arch showing a partial view showing a single abutment base 100 fit onto an implanted dental implant 50 within the host bone and gingival tissue respectively. Embodiments of the present invention provide for parallel alignment of at least two or more such abutment disposed on the same dental arch.

According to embodiments an in situ implanted dental implant 50 is loaded with an abutment base 100 according to embodiment of the present invention. As shown abutment base 100 features a dual connection interface 104 featuring seat 124 that is fit with coupling member 126, shown in the form of a threaded coupling interface 126t.

Abutment base 100 is secured onto implant 50 with a fixation screw 55. Fixation screw is preferably fit with a cap 606 that is introduced with driving tool 600. Cap 606 preferably provides for protecting the long term integrity of fixation screw 55, and in particular the tooling interface of fixation screw 55.

Most preferably coupling member 126 is secured onto abutment base 100 within seat 124 wherein the final placement of coupling member 126 within seat 124 allow for compensating and/or overcoming and/or correcting cumulative misalignment and/or alignment errors. Specifically, use of rigid splint parallel alignment tool 400, provides for ensuring the parallel alignment between abutment bases, as each retentive receiving bore 404 is parallel aligned, and where fine adjustments is provided for by enabling coupling member 126 to properly fit and seat within seat 124, so as to ensure the parallel alignment is achieved between abutment members on the same arch.

Most preferably according to embodiments of the present invention, each receiving bore 404 of a guide member 400 is loaded with an injection sleeve 500, along a proximal portion thereof 502. Flange 504 of injection sleeve rests along an end of receiving bore 404 while distal body portion 502 is associated with coupling member 126.

Next the loaded guide member 400 is associated over abutment bases by introducing coupling member 126 into seat 124. Most preferably, the rigid parallel aligning guide member 400 allows each coupling member associated with corresponding seat 124 allows for passive parallel alignment, as flange 504 of the injection sleeve sits about proximal surface c of abutment base 100. Once seated the injection sleeve 500 is utilized to introduce a cementing and/or composite and/or the like curing agent via injection channel 508 so as to introduce the curing agent into seat 124 and connection interface 104, so as to cement coupling member 126 within seat 124, therein ensuring that once cured the coupling member 126 associated with alignment tool 400 are in parallel alignment. While not shown here, once curing agent has cured the tool 400 and injection sleeve complex are removed in turn. Next a post 200 is associated with coupling member 126. Next, a sleeve 300 is associated with post 200 and thereafter coupled to the restoration.

While the invention has been described with respect to a limited number of embodiments, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Citation or identification of any reference in this application shall not be construed as an admission that such reference is available as prior art to the invention.

Section headings are used herein to ease understanding of the specification and should not be construed as necessarily limiting.

While the invention has been described with respect to a limited number of embodiments, it will be appreciated that many variations, modifications and other applications of the invention may be made.

What is claimed is:

1) A dental implant abutment base (100) assembly comprising at least two abutment bases, each abutment base (100) featuring a body (102) having a dual functioning single internal connection interface (104) including a central channel (105) and a seat (124), said body featuring a distal portion (110) and a proximal portion (120),
a) the distal portion (110) comprises an anchor coupling interface (112) configured to be seated with to an implanted in-situ dental implant anchor;
b) the proximal portion (120) comprising said dual functioning single internal connection interface (104), wherein said central channel (105) spans both said distal portion (110) and a proximal portion (120); and wherein said seat (124) is disposed adjacent to a proximal surface (122) of said proximal portion (120); and wherein said seat (124) is configured to receive a coupling member (126).

2) The assembly of claim 1 wherein said seat (124) has a central axis (124a) that forms an angle of up to 60 degrees relative to a central axis (100a) of said central channel (105).

3) The assembly of claim 1 wherein said dual functioning single internal connection interface (104) is configured to form an open lumen having an open volume accounting for at least 20% of the volume of the proximal portion (120).

4) The assembly of claim 1 wherein said dual functioning single internal connection interface (104) is forms an open lumen having an open volume accounting for up to 90% of the volume of the proximal portion (120).

5) The assembly of claim 1 wherein said dual functioning single internal connection interface (104) is configured to form an open lumen having an open volume accounting for up to 60% of the volume of the proximal portion (120).

6) The assembly of claim 1 wherein said proximal portion (120) is configured to have a hollow portion (120h) said dual functioning single internal connection interface (104) and a solid portion (120s).

7) The assembly of claim 6 wherein said hollow portion accounts for up to 60% of the proximal portion (120).

8) The assembly of claim 6 wherein said hollow portion accounts for up to 90% of the proximal portion (120).

9) The assembly of claim 6 wherein said solid portion (120s) is selected from materials that are one of: solid, partially hollow, trabecular, intermittently hollow, or any combination thereof.

10) The assembly of claim 1 wherein said seat (124) is configured so that a central axis (124a) thereof is positioned to be at an angle theta (θ) relative to a central axis (100a) of the abutment base (100) of up to 60 degrees.

11) The assembly of claim 1 wherein the externa diameter of abutment base 100 is configured to from about 3 mm and up to about 15 mm.

12) The assembly of claim 1 wherein said seat (124) is disposed at any distance distal from the upper surface of said proximal surface (122).

13) The assembly of claim 12 wherein said distance is up to about 5.5 mm (millimeters).

14) The assembly of claim 1 wherein said seat (124) is configured to have an internal diameter (124d) of at least 2 mm and up to about 12 mm.

15) The assembly of claim 1 wherein said seat (124) is configured to have a vertical dimension (124h) of at least 1 mm.

16) The assembly of claim 1 wherein said proximal portion (120) has a vertical dimension from 2 mm (millimeter) and up to about 14 mm (millimeter).

17) The assembly of claim 1 wherein said seat (124) features a coupling member (126).

18) The assembly of claim 17 wherein said coupling member (126) is selected from threading, male/female couplers, and turn lock male/female couplers.

19) The assembly of claim 17 wherein said coupling member (126) is configured to be disposed at an angle beta (β) of up to 60 degrees relative to a central axis (100a).

20) A dental implant abutment formation assembly kit comprising:
a) at least two abutment base members (100) according to claim 1;
b) a parallel guide member (400) featuring at least two parallel bores (404) each bore (404) corresponding to each of said at least two abutment base members (100);
c) at least two injection sleeves (500) associated with said parallel guide member (400); each injection sleeve featuring a distal body member (502), a medial flange (504) and a proximal body member (506) and an injection channel (508); and wherein at least a portion of said proximal body member (506) is disposed internal to said parallel bores (404);
d) at least two coupling member (126) each associated with said distal body member (502) of said injection sleeve (500); and wherein said at least two coupling members (126) are configured to be associated with said at least two abutment base members (100).

21) The assembly kit of claim 20 further comprising at least two post members (200) corresponding to each of said at least two coupling members and/or said at least two abutment base members (100).

22) The assembly kit of claim 20 further comprising at least two sleeve member corresponding to each of said at least two post members (200).

23) The assembly kit of claim 20 further comprising at least two fixation screws (55) for each of said abutment base members (100).

24) The assembly kit of claim 20 further comprising a driver tool member (600), the tool member featuring: a proximal end (601) having a tooling interface (601t) for manipulating said driving tool (600); a body (602); and a distal end (604) featuring a cap member (606) and cap holding arms (608), wherein said cap holding arms (608) extend from said body (602) to secure said cap member (606) and wherein said cap holding arms (608) are configured to disassociate from said cap member (606) when rotational force is applied along said driver (600).
